(19) United States
(12) Patent Application Publication
(10) Pub. No.: US 2005/0074540 A1
(43) Pub. Date: Apr. 7, 2005

(54) Method for manufacturing boiled ground beef vacuum packed in pouch-type bag

(76) Inventor: Jose Barbosa Machado Neto, Itupeva - Sao Paulo (BR)

Correspondence Address: NOTARO AND MICHALOS, 100 DUTCH HILL ROAD, SUITE 110, ORANGEBURG, NY, 10962-2100, US

(21) Appl. No.: 10/686,287

(22) Filed: Oct. 15, 2003

(30) Foreign Application Priority Data
Mar. 23, 2003 (BR) PI 0302375-3

(51) Int. Cl. A23L 1/31

(52) U.S. Cl. 426/646

(57) ABSTRACT

A method for manufacturing boiled ground beef vacuum packed in a pouch-type bag, according to which the end product, which is boiled ground beef, does not need to be stored in cooled environments and can be consumed immediately after the product still contained within the pouch is baked in a microwave oven; the manufacturing method comprising the following stages: A) Provision of raw beef; B) Provision of inputs; C) Storage chamber; D) First Grinding; E) Water treatment; F) Previous boiling; G) Second grinding; H) Mixing; I) Primary packing; J) Sterilization; K) Cooling/Incubation; L) Provision of pouches (plastic/cardboard); N) Primary packing room; M) Secondary packing/storage room.

### TECHNICAL FIELD

The present invention is directed to a method for manufacturing boiled ground beef vacuum packed in a pouch-type bag, said method being especially developed for the preparation of boiled ground beef from the time the good is received until it is wrapped into especial packs suitable to be used in microwave ovens or the like.

### BACKGROUND OF THE INVENTION

In view of the current needs, that is, in view of the scarce time people have to prepare their food, the state of the art has already developed a number of methods especially designed for the preparation of pre-boiled and boiled food in the raw form. Within this view, a number of companies in the food area has started focusing on this niche of trade that is increasingly growing. To accomplish this, large numbers of ready-to-consume products are launched into the consuming market, the most part of which must be refrigerated.

In this sense, it is already known that some methods have been developed for the preparation of products known as “jerky” or “charqui” by making use of industrially produced dehydrated flavored beef or turkey exhibiting a high protein content, being generally made into a dust or paste and wrapped into vacuum packs.

Just for the sake of clarification, products known as “jerky” or “charqui” have been known since ancient Egypt, where it was necessary to dehydrate the food and prepare same with salt or condiments in order to conserve same, since the people used to hunt large-size animals and it usually took several days or even months to consume same.

Still presently, many attempts to produce a “jerky” or “charqui” type product in an industrial scale have resulted in products not fully accepted in some parts of the world, in view of the fact that they are originally supplied in the form of a dust and, for this reason, it easily crumbles, thus losing the initial characteristics of the beef or, in some cases, because of the packing means, the resulting products exhibit artificial characteristics, not providing the real qualities and advantages of the beef in form of “jerky” or “charqui” beef, that is, the products offered can be consumed at any time, anywhere.

### BRIEF DESCRIPTION OF THE DRAWINGS

To complement the present description in order to get a better understanding of the characteristics of the present invention and according to a preferred practical embodiment thereof, attached hereto is a set of drawings wherein the following is shown in an exemplary but not limited way.

FIG. 1 illustrates a block diagram of the present improved method in all its stages;

FIG. 2 illustrates a flowchart of the equipment used in the method in question.

### DETAILED DESCRIPTION OF THE INVENTION

With reference to the illustrated drawings, the present invention is related to a method for manufacturing boiled ground beef vacuum packed in a pouch-type bag, said method for preparing boiled ground beef including from the procedures used for receiving the goods to the industrial procedure that wraps same into pouch-type bags, ready to be used in microwave ovens or the like.

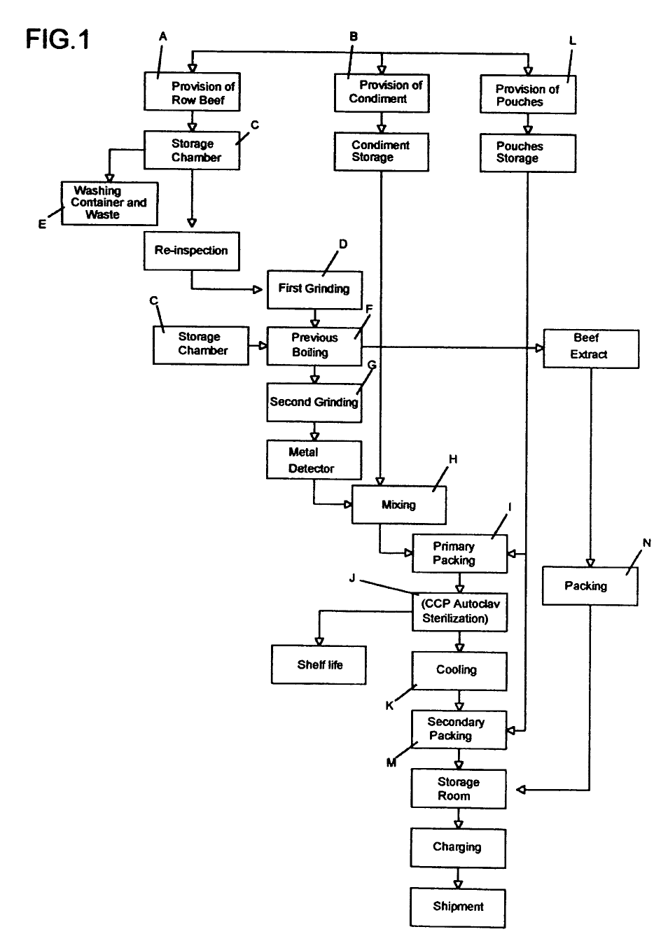

The manufacturing method consists of the following stages (according to FIG. 1):
A) Provision of Raw Beef:

Qualitative evaluation of the raw beef, by checking:
Provision of the beef packed in containers, duly wrapped in plastics;
Date of validity and production (manufacture);
Fairly good conditions of the pouches;
Odor, color, appearance to exhibit fresh beef characteristics;

The temperature, pH and fat must be within the following standards:
Temperature:

Safe Limits: −1° C.<T≦7° C.

Critical Limit: T=−1 and 5,6° C.≦T≦7° C.
pH:

Safe Limit: 5.4<pH≦5.9

Critical Limit: pH:=5.4 and pH=6.0
Fat

Fat content: 8% to 12%.
B) Provision of Inputs:

at every provision, the quality control inspector makes an inspection by checking the presence of: dirtiness, rips and punctures in the pouches, the analysis report on the supplier among others; the pouches of each lot received are identified and numbered sequentially; the pouch is weighted and checked at random.
C) Storage Chamber:

the plastic pouches that wrap the beef are removed and placed into closed carts and then conveyed to the discarding section;

the raw beef is stored in accordance with the date of manufacture, the beef bearing the oldest dates being piled to be used firstly (PEPS).

the pouches must not be in contact with the floor and must be piled on pallets, a gap being provided between the pouches and the pallets;

the pouches must be handled carefully, and care should be taken not to throw or drag same. They must be identified individually;

the door of the storage chamber must be kept closed;

only the sufficient amount of beef to be used should be taken from the chamber, thus preventing that it is exposed to the environment for a long time;

the environment is cooled between 7° C. and 10° C.;

before being submitted to the grinding process, the raw beef must be checked in a re-inspection site, wherein the temperature, pH and other relevant items are checked.
D) First Grinding:

the beef is transferred to a grinding mill provided with a 1 inch diameter disc;

the temperature of the environment must be in an interval between 7° C. and 10° C.;

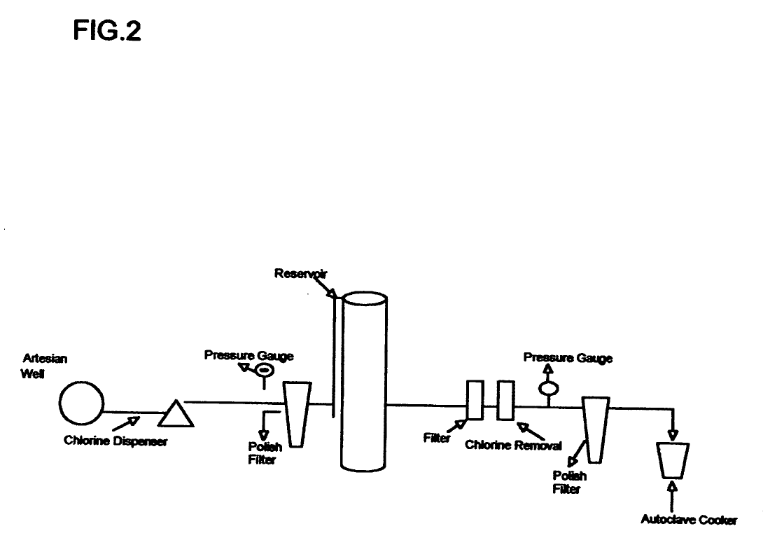

in this stage, the danger consists in the presence of physical contaminants resulting from the grinding, which contaminants will be eliminated through the use of a metal detector and/or visual inspection.
E) Water Treatment: (see FIG. 2)

Source of water: artesian well;

Chlorine dispenser: a device provided with a peristaltic pump for the product with a 45 rpm engine actuated by an electronic board that controls the engine speed, a led indicating that the device is on and dispensing, a delay timer for inputting the dosage within a period from 0 to 3 minutes, wherein the time regulated for the input of products before or after can be selected through a JUMP, shown on the board through adequate commands; the enclosures of the pumps are coated with special resins, thus providing high resistance to the action of chemicals, temperature, expansion and shocks, the rolls of which are made of ultrahigh molecular weight PP and attached through bolts to stainless steel 340 supports.

Filtering through a polishing filter: Polypropylene filter (50 microns filtering element);

Chlorine removal: Gr activated carbon (Removal of chlorine through a carbon filter);

Filtering through a polishing filter: Polypropylene filter (10 microns filtering element).

The water pumped from the well passes through an automated chlorinator and then through a polishing filter and ultimately stored in a reservoir. Afterwards, it passes through the chlorine removing unit and the polishing filter.

In the water treatment, a series of controls, that is, the microbiological control of the output water, is carried out; the control of the efficacy of the activated carbon by analyzing the waste chlorine is carried out in the output water, wherein the presence of waste chlorine will indicate that the coal is saturated and/or the flow rate through the chlorine removing unit is above the range therefor; and the control of the polishing filter through the pressure gauge installed at the entrance of the chlorine removing unit, wherein, if the pressure gauge indicates a load loss above 2.5 the cartridge of the polishing filter must be changed.
F) Previous boiling: (FIG. 1)

After the grinding, the process for feeding the cookers is continuous;

The ground beef is submitted to a previous baking in treated water for a minimum period of time of 10 minutes at the water boiling temperature;

the water boiling temperature (100° C.) is repeatedly monitored every hour.
G) Second Grinding:

After the ground beef is boiled, it is submitted to a second grinding by using a ⅛ inch diameter disc;

In this stage, the danger consists in the presence of physical contaminants resulting from the grinding, which contaminants will be eliminated through the use of a metal detector and/or visual inspection by the end of the second grinding.
H) Mixing:

In the mixer, the pre-boiled ground beef is mixed with all the ingredients, thus producing a mixture at a suitable time;

The weighting of the ingredients added to the mixer is followed by quality control inspector and the weight is recorded in a weigh control sheet.
I) Primary Packing:

Before being put into the autoclave, the pouch is fed periodically at defined intervals into the product shaping section;

The ground beef is packed into flexible bags (pouches)—a seal resistant to the sterilization processes.

These bags are used for low and high acidity food, either for aseptic systems or for autoclaves. The external side thereof is made of polyester so that they can last longer, and its side facing the food is made of polypropylene, with a barrier of oxygen—polyvinylidene chloride, EVOH, or nylon. The polypropylene may be pigmented with titanium oxide to function as a barrier to the light, or an aluminum foil may replace the PVDC as the barrier to the light.

The bag filling operation is a critical stage, since it is essential that bag be filled as far as the proper level with the product and it does not contact the sealing area. The excessive filling of the bag must be prevented because it may increase the potential of contamination by the seal and failures in the sealing, as well as lead to an under-processing due the higher thickness.

In this stage, the quality control inspector checks the sealing, weight, micro-punctures, vacuum.
J) Sterilization:

The purpose of this stage is to eliminate or reduce to an acceptable level the possibility of a danger to the food safety, and for this reason the monitoring thereof is of the utmost importance;

A temperature/time recording device is used in conjunction with the temperature recording device;

The beef is submitted to a sterilization process in the autoclave for a period of 20 minutes at 121.5° C.

The emergency situations that can affect the product severely would be the ones occurred during the heat processing. Thus, in the event of lack of steam or any other element that may affect the heat process before it has reached the steam removing phase, the following should be carried out:

Carry out the compensations related to the temperature fall period;

Segregate the raw material during the incubation, and carry out microbiological and physical-chemical analyses;

Identify and correct the cause of the non-conformity;

Notify the quality control supervisor.

In the autoclave, a number of equipment is installed:

Mercury thermometer—checked daily and every 6 months versus a standard instrument tracked by the RBC;

Pressure gauge—checked daily and every 6 months versus a standard instrument tracked by the RBC;

Time/temperature meter—checked daily and every 6 months versus a standard instrument tracked by the RBC;

The recordings from different types of control are filed in the quality control department.

All the recordings are verified by the quality control supervisor and/or coordinator of the programs.
K) Cooling/Incubation:

The bags (pouches) must be cooled to 35° C. rapidly in chlorinated water (5 ppm) so that they can retain sufficient heat to dry same;

After the cooling, one unit is collected every 1000 and incubated in a room the temperature of which is from 34° C. to 38° C, for a period of 10 days for the purpose of stimulating the growth of microorganisms that may be present therein;

During the incubation, the pouches are checked for any leakage, swollen pouches and other physical defects. In the event any defect is found outside the regular standards or if there is any processing imperfection, the lot will be put aside until the results of the laboratory analysis are supplied;

The products will be released only after the laboratory analysis results are issued.
L) Provision of the Pouch (Plastic/Cardboard):

When the pouches are received, a visual inspection is conducted by checking: dirtiness, organization, rips, punctures, etc. In the event it presents one of these problems the pouch is separated and sent to the relevant department;
M) Primary Packing Room;

After the cooling period, the product is packed in flexible bags (pouches);

The pouches are vacuum closed. (the process control devices are checked periodically or as required);

The room is kept at the ambient temperature.
N) Secondary Packing/Storage Room:

The products are packed into duly identified cardboard boxes;

Before the shipment, the following items are checked out:
Visual inspection of the pouch, tag and cleanness, the comments being duly recorded together with other pertinent details, such as the destination, means of transportation, among others;
PCC Record—revised by the quality control inspector, packing manager and the employee responsible for the final release to guarantee the control within critical limits.

The end product, that is, boiled ground beef, does not need to be stored in cooled environments and can be consumed immediately, and for such purpose it is enough to place the pouch directly into the microwave oven so that it will be ready for the human consumption in a few minutes.

Although details of the invention have been disclosed, it is important to realize that its application is not restricted to the details and stages described herein. The invention may show other embodiments and practiced or realized in a number of ways. It should be understood that the terminology used herein is intended to describe but not limit the invention.

1. A method for manufacturing boiled ground beef vacuum packed in a pouch-type bag, the manufacturing method being characterized by comprising the following stages:
A) provision of raw beef;
B) provision of inputs;
C) storage chamber;
D) first grinding;
E) water treatment;
F) previous boiling;
G) second grinding;
H) mixing;
I) primary packing;
J) sterilization;
K) cooling/incubation;
L) provision of pouches (plastic/cardboard);
N) primary packing room;
M) secondary packing/storage room:

2. The method according to claim 1, characterized in that the Provision of Raw Beef stage comprises the following:
the qualitative evaluation of the raw beef, by checking:
provision of the beef packed in containers, duly wrapped in plastics;
date of validity and production (manufacture);
fairly good conditions of the pouches;
odor, color, appearance to exhibit fresh beef characteristics;
the temperature, pH and fat must be within the following standards:
Temperature:
Safe Limits: −1° C.≦T≦7° C.
Critical Limit: T=−1 and 5,6° C.≦T≦7° C.
pH:
Safe Limit: 5.4<pH≦5.9
Critical Limit: pH:=5.4 and pH=6.0
Fat
Fat content: 8% to 12%.

3. The method according to claim 1, characterized in that the Storage Chamber stage comprises the following:
the environment is cooled between 7° C. and 10° C.;
before being submitted to the grinding process, the raw beef must be checked in a re-inspection site, wherein the temperature, pH and other relevant items are checked.

4. The method according to claim 1, characterized in that the First Grinding stage comprises the following:
the beef is transferred to a grinding mill provided with a 1 inch diameter disc;
the temperature of the environment must be in an interval between 7° C. and 10° C.

5. The method according to claim 1, characterized in that the Water Treatment stage comprises the following:
Source of water.
Chlorine dispenser: a device provided with a peristaltic pump for the product with a 45 rpm engine actuated by an electronic board that controls the engine speed, a led indicating that the device is on and dispensing, a delay timer for inputting the dosage within a period from 0 to 3 minutes, wherein the time regulated for the input of products before or after can be selected through a JUMP, shown on the board through adequate commands; the enclosures of the pumps are coated with special resins, thus providing high resistance to the action of chemicals, temperature, expansion and shocks, the rolls of which are made of ultrahigh molecular weight PP and attached through bolts to stainless steel 340 supports.
Filtering through a polishing filter: Polypropylene filter (50 microns filtering element);
Chlorine removal: Gr activated carbon (Removal of chlorine through a carbon filter);
Filtering through a polishing filter: Polypropylene filter (10 microns filtering element).

6. The method according to claim 1, characterized in that the Previous Boiling stage comprises the following:
after the grinding, the process for feeding the cookers is continuous;
the ground beef is submitted to a previous baking in treated water for a minimum period of time of 10 minutes at the water boiling temperature;
the water boiling temperature (100° C.) is repeatedly monitored every hour.

7. The method according to claim 1, characterized in that the Second grinding stage comprises the following:
after the ground beef is boiled, it is submitted to a second grinding by using a ⅛ inch diameter disc.

8. The method according to claim 1, characterized in that the Mixing stage to understand that:
In the mixer, the pre-boiled ground beef is mixed with all the ingredients, thus producing a mixture at a suitable time.

9. The method according to claim 1, characterized in that the Primary Packing stage comprises the following:
before being put into the autoclave, the pouch is fed periodically at defined intervals into the product shaping section;
the ground beef is packed into flexible pouch-type bags—a seal resistant to the sterilization processes.

10. The method according to claim 1, characterized in that the Sterilization stage comprises the following:
a temperature/time recording device is used in conjunction with the temperature recording device;
the beef is submitted to a sterilization process in the autoclave for a period of 20 minutes at 121.5° C.;
In the autoclave, a number of equipment is installed:
Mercury thermometer—checked daily and every 6 months versus a standard instrument tracked by the RBC;
Pressure gauge—checked daily and every 6 months versus a standard instrument tracked by the RBC;
Time/temperature meter—checked daily and every 6 months versus a standard instrument tracked by the RBC.

11. The method according to claim 1, characterized in that the Cooling/Incubation stage comprises the following:
the bags (pouches) must be cooled to 35° C. rapidly in chlorinated water (5 ppm) so that they can retain sufficient heat to dry same;
after the cooling, one unit is collected every 1000 and incubated in a room the temperature of which is from 34° C. to 38° C. for a period of 10 days for the purpose of stimulating the growth of microorganisms that may be present therein.

12. The method according to claim 1, characterized in that the Primary packing room stage comprises the following:
after the cooling period, the product is packed in flexible bags (pouches);
the pouches are vacuum closed. (the process control devices are checked periodically or as required);
the room is kept at the ambient temperature.

13. The method according to claim 1, characterized in that the Secondary packing/storage room stage comprises the following:
The products are packed into duly identified cardboard boxes, submitted to a visual inspection of the pouch, tag and cleanness, the comments being duly recorded together with other pertinent details.
